(19) United States
(12) Patent Application Publication
(10) Pub. No.: US 2006/0194887 A1
(43) Pub. Date: Aug. 31, 2006

(54) Method of controlling aggregation and dispersion of magnetic nano particles, method of capturing magnetic nano particles, and method of treating a magnetic nano particle-containing liquid

(75) Inventors: Masayoshi Kojima, Kanagawa (JP); Hiroyuki Hirai, Kanagawa (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD.

(21) Appl. No.: 11/362,055

(22) Filed: Feb. 27, 2006

(30) Foreign Application Priority Data
Feb. 28, 2005 (JP) 2005-054938

(51) Int. Cl. B01F 17/00; C09K 3/00

(52) U.S. Cl. 516/113; 977/840

(57) ABSTRACT

The present invention provides a method of controlling aggregation and dispersion of magnetic nano particles, the method including changing, in a sample liquid containing independently dispersed magnetic nano particles having a particle size of 1 to 50 nm, at least one condition selected from the type of a salt present as a medium, the concentration of the salt, and the pH of the sample liquid to thereby control aggregation and dispersion of the magnetic nano particles.

### CROSS-REFERENCE TO RELATED APPLICATION

This application claims priority under 35 USC 119 from Japanese Patent Application No. 2005-054938, the disclosure of which is incorporated by reference herein.

### BACKGROUND OF THE INVENTION

1. Field of the Invention

The present invention relates to a method of controlling aggregation and dispersion of magnetic nano particles, a method of capturing magnetic nano particles and a method of treating a liquid containing magnetic nano particles, and in particular to a method of controlling aggregation and dispersion of magnetic nano particles in an aqueous solution, a method of capturing magnetic nano particles in an aqueous solution, and a method of treating such a magnetic nano particle-containing liquid.

2. Description of the Related Art

In recent years, magnetic particles have been proposed as a means of efficiently collecting a target substance. Magnetic particles can be collected easily and efficiently by using an external magnetic field, and is thus used as a method of detecting a biological substance, etc. and as an accurate detection means in a diagnostic method (for example, Bio Industry, 2004, Vol. 21, No. 8, pp39-47).

As the diameter of the magnetic particles used are increased, their response to a magnet is improved, however the amount of the target substance adsorbed thereon and analytical sensitivity are not satisfactory, while when the diameter of the particles are decreased to several tens nm or less, their responsiveness to a magnet is lowered to make accurate analysis difficult.

Accordingly, there is proposed aggregation of magnetic nano particles by utilizing a polymer having lower-limit critical solution temperature (LCST) or upper-limit critical solution temperature (UCST) such that even nano-class magnetic nano particles can respond certainly to an external magnetic field thereby certainly and accurately analyzing a trace amount of a target substance in a sample (for example, Bio Industry, 2004, Vol. 21, No. 8, pp3l-38, International Publication No. WO 02/16571, International Publication No. WO 02/16528, and Japanese Patent Application Laid-Open (JP-A) No. 2002-60436).

However, when the above heat stimulation-responsive polymer is used in the aggregation step, there may arise a problem such as reduction in the efficiency of separation and purification due to unspecific interaction between a target substance such as virus and a polymer chain.

### SUMMARY OF THE INVENTION

The present invention has been made in view of the above circumstances and provides a method of controlling aggregation and dispersion of magnetic nano particles by which even a trace amount of a target substance can be rapidly and efficiently separated and purified, a method of capturing magnetic nano particles and a method of treating a magnetic nano particle-containing liquid.

A first aspect of the invention provides a method of controlling aggregation and dispersion of magnetic nano particles, the method comprising changing, in a sample liquid containing independently dispersed magnetic nano particles having a particle size of 1 to 50 nm, at least one condition selected from the type of a salt present as a medium, the concentration of the salt, and the pH of the sample liquid to thereby control aggregation and dispersion of the magnetic nano particles.

A second aspect of the invention provides a method of capturing magnetic nano particles, the method comprising: changing, in a sample liquid containing independently dispersed magnetic nano particles having a particle size of 1 to 50 nm, at least one condition selected from the type of a salt present as a medium, the concentration of the salt, and the pH of the sample liquid to thereby aggregate the magnetic nano particles; and subjecting the aggregated magnetic nano particles to an external magnetic field to thereby capture the particles.

A third aspect of the invention provides a method of treating a liquid containing magnetic nano particles, the method comprising changing, in a sample liquid containing independently dispersed magnetic nano particles having a particle size of 1 to 50 nm and having a carboxylic acid group thereon, the pH of the sample liquid to less than 5 to thereby aggregate the magnetic nano particles.

### BRIEF DESCRIPTION OF THE DRAWING

FIG. 1 is a graph showing the relationship between the concentration of a salt in a sample liquid and the sedimentation rate of magnetic nano particles in the Examples according to the present invention.

### DETAILED DESCRIPTION OF THE INVENTION

The method of controlling aggregation and dispersion of magnetic nano particles according to the present invention includes changing, in a sample liquid containing independently dispersed magnetic nano particles having a particle size of 1 to 50 nm, at least one condition selected from the type of a salt present as a medium, the concentration of the salt, and the pH of the sample liquid to thereby control dispersion and aggregation of the magnetic nano particles.

[1] Magnetic Nano Particles

The magnetic nano particles in the invention are nano particles with magnetism having an average particle diameter of 1 to 50 nm. The average particle diameter is 1 nm or more, so the nano particles can be produced stably, and the diameter is 50 nm or less, so even if a substance in a cell is a target, the nano particles can penetrate into the cell to capture the target substance. The surface of the magnetic nano particle is so large that the efficiency of reaction is high and a trace amount of a target substance can be rapidly captured. The average particle diameter of the magnetic nano particles is preferably 3 to 50 nm, and more preferably 5 to 40 nm, from the viewpoint of crystal stability and magnetic response.

Such magnetic nano particles can be produced by a method described in, for example, Japanese Patent Application National Publication (Laid-Open) No. 2002-517085. For example, an aqueous solution containing an iron(II) compound, or iron(II) compound and metal(II) compound, is placed under oxidizing conditions necessary for forming magnetic oxides, and the solution is kept in a range of pH of 7 or more, whereby iron oxide or ferrite magnetic nano particles can be formed. By mixing an aqueous solution containing a metal(II) compound with an aqueous solution containing iron(III) under alkaline conditions, the magnetic nano particles of the invention can also be obtained. Further, a method described in Biocatalysis, 5:61-69, 1991 can also be used.

In the invention, preferable magnetic nano particles are selected from the group consisting of metal oxides, particularly iron oxides and ferrite (Fe, M)₃O₄. The iron oxides particularly include magnetite, maghemite, and mixtures thereof. The magnetic nano particle may have a core/shell type structure different in the surface and the inside. In the above formula, M is a metal ion, which can be used together with the iron ion to form a magnetic metal oxide, and is typically selected from transition metals and is most preferably Zn²⁺, Co²⁺, Mn²⁺, Cu²⁺, Ni²⁺ or Mg²⁺, and the molar ratio of M/Fe is determined according to the stoichiometric formulation of the selected ferrite. The metal salt is fed in the form of solid or solution, and is preferably chloride, bromide or sulfate.

Among these, iron oxides are preferable from the viewpoint of safety.

To form magnetite, iron is present preferably in two different oxidation states, Fe²⁺ and Fe³⁺, in a solution. The two different oxidation states can occur in a solution by adding a mixture of iron(II) and iron(III) salts, preferably in a slightly higher molar ratio of Fe(II) to Fe(III) relative to the molar ratio of Fe(II) to Fe(III) in the formulation of intended magnetic oxide, or by adding an iron(II) or iron(III) salt and then converting a part of Fe²⁺ or Fe³⁺ into another oxidation state as required, preferably through oxidation, or through reduction depending on the case.

The magnetic metal oxide is preferably aged at a temperature of 30° C. to 100° C., preferably at a temperature between 50° C. and 90° C.

The pH value of the solution should be 7 or more for causing interaction among various metal ions to form magnetic metal oxides. The pH value is kept in a desired range by using a suitable buffer solution as an aqueous solution to which the metal salt is added at first, or by adding a base to the solution after attaining a necessary oxidation state. A specific pH value, once selected in the range of pH of 7 or more, is kept preferably throughout the process of preparing magnetic nano particles in order to secure substantially uniform size distribution of the final products.

For the purpose of controlling the sizes of magnetic nano particles, the process may further include a step of adding an additional metal salt to the solution. In this case, the process can be carried out in the following different operation modes. One operation mode involves stepwise increase, and is referred to hereinafter as the stepwise operation mode, and in this operation mode, the respective components (metal salt, oxidizing agent and base) are divided into several portions (preferably equally) and successively added to the solution in a predetermined order, and these steps are repeated until the nano particles of intended size are obtained, and the amount of the components added each time is such that polymerization of metal ions can be substantially prevented in the solution (that is, except for on the surface of the particle).

The other mode is a continuous operation mode, in which the respective components (metal salt, oxidizing agent and base) are added, in a predetermined order, continuously to a solution at such substantially uniform respective flow rates that polymerization of metal ions can be prevented except for on the surface of the particle. By using the stepwise or continuous operation mode, particles having a narrow size distribution can be formed.

[2] Surface Modifier

The surface modifier according to the invention may be a compound having a hydrophilic functional group, and is particularly preferably a compound represented by formula (I):
R¹O—(CH₂CH₂O)ₙ—L—X (I)

In the formula, R¹ is a hydrophobic group, and represents an alkyl or alkenyl group having a carbon chain length of 1 to 20, or a phenyl group which is unsubstituted or substituted with an alkyl or alkoxyl group having a carbon chain length of 10 or less. From the viewpoint of dispersion stability in an aqueous medium, R¹ is preferably an alkyl group having a carbon chain length of 5 to 20.

In the formula, L may be or may not be present, and when present, L represents an alkylene group having a carbon chain length of 1 to 4, and from the viewpoint of dispersion stability, L preferably represents an alkylene group having a carbon chain length of 1 to 2. This alkylene group may have a branched chain, and the branched chain may be a methyl group.

In the formula, X is an acid group and represents a carboxylic acid group, phosphoric acid group, sulfonic acid group or boric acid group, and is preferably a carboxylic acid group, which can be easily bound to various molecules. These acid groups may form salts with organic or inorganic cations.

In the formula, n is an integer of 1 to 10, and from the viewpoint of dispersion stability, n is preferably an integer of 1 to 6.

Examples of the surface modifier in the invention include:

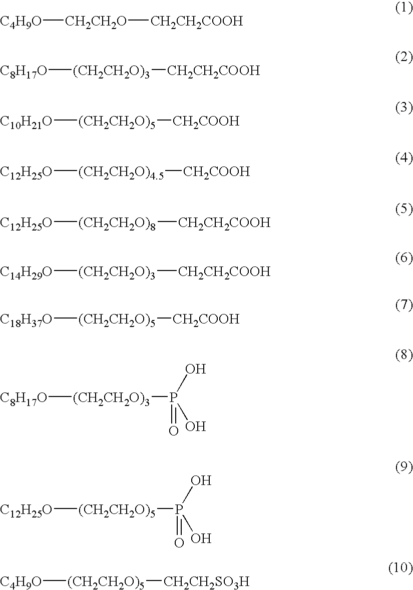

Among these, from the viewpoint of easily binding to a compound having an affinity for a target substance, the surface modifier in the invention is particularly preferably (1) to (7).

By the surface modifier of formula (I) in the invention, a large number of functional groups capable of binding to a compound (hereinafter, referred to as a ligand) having an affinity for a target substance can be arranged on the surface of the magnetic nano particle. The density of the functional groups (the amount of the added surface modifier) arranged on the surface of the magnetic nano particle varies depending on the type and size of the target substance and magnetic nano particle. The amount of the surface modifier bound to the surface of the particle can be confirmed by chemical analysis, and a suitable analysis method can be easily selected by those skilled in the art.

In the invention, the surface modifier can be carried in high density on the surface of the magnetic nano particle, however if the amount of the surface modifier is sufficient as a whole, the surface modifier may cover the magnetic nano particle entirely or may be bound to a part of the particle. In the invention, the surface modifiers may be used alone or as a mixture of two or more thereof.

In the invention, a known surface modifier (for example, polyethylene glycol, trioctyl phosphine, trioctyl phosphine oxide, sodium polyphosphate, sodium bis(2-ethylhexyl)sulfosuccinate, etc.) may be allowed to be coexistent with the above surface modifier during or after preparation of the nano particles.

The addition amount of the surface modifier according to the invention, though varying depending on the size of the magnetic nano particle, the density of the particles, the type (size, structure) of the surface modifier and the type and size of the target substance, is preferably 0.001 to 10 molar equivalent, more preferably 0.01 to 2 molar equivalent with respect to the magnetic nano particles.

In the invention, a known surface modifier can be used as described above in addition to the surface modifier of the invention represented by the formula (I). The amount of the known surface modifier added is not particularly limited, but is preferably 0.01 to 100 molar equivalent, more preferably 0.05 to 10 molar equivalent.

The surface modifier according to the invention can be added during or after preparation of the magnetic nano particles, and binds to the magnetic nano particle, so that at least a part of the surface of the nano particle is coated (surface-modified) therewith. When the surface modifier is added after preparation of the magnetic nano particles, the magnetic nano particles are preferably purified by magnetic separation, but may be washed and purified by a ordinary method such as centrifugation or filtration, and then the magnetic particles are dispersed in a solvent (preferably water or a hydrophilic organic solvent such as methanol, ethanol, isopropyl alcohol or 2-ethoxyethanol) containing the surface modifier used in the invention to coat the particles therewith. When the surface modifier is added during preparation of the magnetic nano particles, the particles can be purified by known methods such as magnetic separation, centrifugation, ultrafiltration, gel filtration or electrophoresis.

Coverage of the surface of the magnetic nano particle with the surface modifier can be confirmed by chemical analysis and by recognizing the presence of predetermined intervals among the particles when observed with high-resolution TEM such as FE-TEM.

The magnetic nano particles coated with the surface modifier represented by the formula (I) in the invention can be activated so as to bind by amidation reaction or the like to a ligand described later in detail, via the reactive group X in the formula, that is, the terminal group of the surface modifier.

The amidation reaction proceeds by condensing a carboxyl group or its derivative group (ester, acid anhydride, acid halide, etc.) with an amino group. When an acid anhydride or acid halide is used, a base is desirably allowed to be coexistent. When an ester such as methyl carboxylate or ethyl carboxylate is used, heating or reduced pressure is desirably used to remove formed alcohol. When a carboxyl group is directly amidated, amidation reagents such as DCC, Morpho-CDI and WSC, condensation additives such as HBT, and amidation reaction accelerators such as active esters such as N-hydroxy phthalimide, p-nitrophenyl trifluoroacetate and 2,4,5-trichlorophenol may be allowed to be coexistent or may be previously reacted. At the time of amidation reaction, either an amino group or a carboxyl group of a molecule having affinity to be bound through amidation is desirably protected with a suitable protective group in an ordinary manner and is deprotected after the reaction.

The magnetic nano particles bound by the amidation reaction to a ligand are washed and purified by ordinary methods such as gel filtration and then used by dispersing them in water or a hydrophilic solvent (preferably methanol, ethanol, isopropanol, 2-ethoxyethanol, etc.). The concentration of the magnetic nano particles in this dispersion liquid varies depending on the type and concentration of the target substance and ligand, and is not particularly limited, but is preferably 1 M to 10⁻⁸ M, more preferably 10⁻² M to 10⁻⁷ M.

[3] Sample Liquid

The magnetic nano particles according to the invention are independently dispersed in a sample liquid. The terms “independently dispersed” refers to the state in which the magnetic nano particles are dispersed substantially uniformly in a sample liquid, and the individual nano particles are not bound to one another, or even if the nano particles are bound to one another, they can be easily separated from one another by a physical means such as shaking.

The concentration of the magnetic nano particles in a sample liquid varies depending on the type of the magnetic nano particles and the type of the sample liquid, however generally speaking, the concentration is preferably in the range of 0.01 g/L to 50 g/L from the viewpoint of dispersion stability.

The sample liquid containing the magnetic nano particles independently dispersed therein refers to a liquid sample possibly containing a target substance as a substance to be detected, and varies depending on applications such as analysis by the magnetic nano particles, and the sample liquid may be an aqueous solution having viscosity with which the magnetic nano particles can be aggregated and dispersed.

In the invention, the dispersion and aggregation of the magnetic nano particles are controlled by changing at least one condition selected from the type of a salt present as a medium, the concentration of the salt and the pH of a sample liquid. One condition selected from the type of a salt present as a medium, the concentration of the salt and the pH of a sample liquid, or a combination of two or more thereof, may be used.

Examples of the salt contained in a sample liquid wherein the magnetic nano particles are aggregated and dispersed include a salt of multivalent cation and/or multivalent anion.

The salt of multivalent cation may be a magnesium salt, calcium salt, manganese salt, etc., while the salt of multivalent anion may be a phosphate, sulfate, borate, or polyacid salt such as phosphorus tungstate or phosphorus molybdate, dextran sulfate, and sulfate polysaccharides of heparin, etc. Among these, phosphates capable of preparing a buffer solution in a broad pH range are preferable.

Usually, the magnetic nano particles can be stably dispersed in purified water, physiological saline and various buffer solutions such as GOOD buffer solution, depending on the concentration of the particles in a sample liquid. Preferably, the concentration of various salts in the sample liquid is generally 0.1 M or less from the viewpoint of long-term storage stability.

To aggregate the magnetic nano particles, a salt containing a multivalent cation or multivalent anion may be added to the dispersion liquid, and an aqueous dispersion liquid of the magnetic nano particles containing 5.0 g/L iron oxide can be easily aggregated by adding an equivalent amount of 0.2 M phosphate buffer.

The pH value of the sample liquid in aggregating or dispersing the magnetic nano particles by adding a salt is desirably 5 or more. From the viewpoint of purifying and separating a biological material, the pH value is preferably 5 to 10. Depending on the stability of a substance handled, the temperature can be set arbitrarily in an aqueous solution. When the aggregation and dispersion of the magnetic nano particles are carried out by changing pH, the magnetic nano particles can be dispersed at a pH value of 5 or more and aggregated at a pH value of less than 5. Particularly, when a carboxylic acid group is present on the surface of the magnetic nano particle, it is preferable for efficient aggregation and dispersion that the aggregation condition is pH of less than 5, and the dispersion condition is pH of 5.

For changing the concentration of the salt, the type of the salt and/or the pH of the sample liquid, a salt solution may be added to the sample liquid containing the magnetic nano particles so as to attain a desired salt concentration and type or pH value. The salt solution, though varying depending on the type of the magnetic nano particles and the type and concentration of the sample liquid, may generally be a buffer solution containing a multivalent cation or multivalent anion and can be, for example, phosphate buffer (pH of 5 to 9), citrate/phosphate buffer (pH of 5 to 9), etc. For controlling aggregation and dispersion by pH, an arbitrary buffer solution can be used.

Particularly, when the magnetic nano particles in the invention are surface-modified with the surface modifier represented by the formula (I) above, such aggregation and dispersion can be conducted very easily.

For dispersing the aggregated magnetic nano particles, on one hand, the concentration and type of the salt and the pH of the sample liquid may be returned again to those before dispersion, and a salt solution of desired type and/or concentration may be added or the salt concentration may be decreased with purified water.

By changing the type and/or concentration of the salt in this way, the magnetic nano particles can be aggregated and dispersed in a sample liquid. When ligands enabling linkage with a target substance in the sample are present on the surfaces of the magnetic nano particles, the particles can be aggregated and dispersed together with the target substance.

[4] Ligand

The magnetic nano particles in the invention can bind via a ligand to a target substance. The target substance and the ligand can be changed suitably depending on the field to which the magnetic nano particles in the invention is applied.

Such ligands include biologically related molecules and various organic/inorganic compounds having affinity for biologically related molecules.

With respect to biologically related molecules, a combination of “ligand/target substance” which can be expected to show affinity interaction is, for example, hybridization of nucleic acid molecules, (monoclonal and polyclonal) antigen and antibody, enzyme and substrate, nucleic acid and protein, avidin-biotin, etc. The biologically related molecule serving as ligand may be nucleic acid, amino acid, peptide, protein, polysaccharides and also lipid.

For example, when nucleic acid is used, a transcription controlling factor capable of controlling the transcription of various nucleotide sequences can be rapidly and easily separated from various proteins. By using various substances, the relationship among the various substances, for example, the strength of interaction, similarity of structure, etc. can be recognized.

In a narrow sense, the “nucleic acid” is deoxyribonucleic acid (DNA) and ribonucleic acid (RNA), and in a broad sense, examples of the nucleic acid may include PNA (peptide nucleic acid). Examples of RNA include mRNA, tRNA and rRNA. Examples of the nucleic acid include not only the whole DNA or RNA but also a fragment of DNA or RNA.

The target substance may be living things such as virus and bacteria or a part thereof. As the ligand, lectin or the like can be used.

[5] Method of Capturing the Magnetic Nano Particles

The method of controlling aggregation and dispersion of the magnetic nano particles of the invention can then be applied to a method of capturing the magnetic nano particles including a step of capturing the aggregated magnetic nano particles by subjecting them to an external magnetic field.

In the invention, as described above, the magnetic nano particles are rapidly aggregated and disperse by changing the salt concentration, type and/or pH of the sample liquid. An aggregate of the magnetic nano particles obtained by aggregation can respond to an external magnetic field, so when the magnetic nano particles bind via a ligand on the surface thereof to a target substance present in a trace amount in a sample liquid, the target substance present in a trace amount can be rapidly and accurately captured.

The intensity of the external magnetic field used herein is preferably 7.96 to 1592 kA/m (100 to 20000 Oe), more preferably 23.9 to 1274 kA/m (300 to 16000 Oe). The external field can be applied by using a permanent magnet.

Application of the external magnetic field may be carried out by passing a mixed liquid containing a sample to be detected and the magnetic nano particles at a constant rate through the external magnetic field, or by batch treatment in a container.

The capturing method of the invention may include a separation step of separating and purifying, from the sample liquid, an aggregate of the magnetic nano particles captured by the external magnetic field. As the means of separating the aggregate from the sample liquid, a known method used in such object, such as collecting the aggregate or removing the sample liquid and then terminating application of the external magnetic field or shielding from the external magnetic field, can be used as it is.

In this way, an aggregate of the magnetic nano particles onto which the target substance is bound can be obtained in high concentration and can be separated easily from the sample liquid.

The capturing method of the invention may include a step of re-suspending the aggregate of the magnetic nano particles captured in the capturing step by changing the salt concentration, etc. A dispersion product of the magnetic nano particles can thereby be obtained again.

This re-dispersion may be carried out in the sample liquid from which the aggregate was obtained, or may be carried out in another solution after the aggregate was separated from the sample liquid by the separation step.

When the target substance is bound via a ligand to the magnetic nano particles, the target substance can be efficiently collected. By controlling the volume in dispersing, a solution of the target substance can be obtained at desired concentration, and the target substance can be easily obtained for example at high concentration. By this re-dispersion, the target substance can be easily and rapidly concentrated and purified.

The invention may be treatment including changing magnetic nano particles into an aggregated or dispersed state in a solution containing the magnetic nano particles, and is not limited to only applications intended mainly to capture and collect the magnetic nano particles or a target substance bound to the magnetic nano particles. Other applications include concentration or purification of a substance in a sample liquid or removal of a specific substance from a mixed solution. Accordingly, the invention can be used in treatment for every object and applications including change of the behavior of a substance in a sample liquid containing magnetic nano particles.

### EXAMPLES

Hereinafter, the present invention will be described in detail by reference to the Examples, but is not limited to the Examples. In the Examples, % is on a weight (mass) basis unless otherwise specified.

### Example 1

### Preparation of a Dispersion Liquid of Magnetic Nano Particles

10.8 g of iron chloride(III).6H₂O and 6.4 g of iron chloride(II).4H₂O were respectively dissolved in 80 ml of 1 N aqueous solution of hydrochloric acid, and mixed together. While this solution was stirred, 96 ml of ammonia water (28 wt %) was added thereto at a rate of 2 ml/min. Thereafter, the mixture was heated at 80° C. for 30 minutes and then cooled to room temperature. The resulting aggregate was purified with water by decantation. Formation of magnetite (Fe₃O₄) having a crystal size of about 12 nm was confirmed by X-ray diffraction.

To this aggregate was added 100 ml of an aqueous solution (adjusted to pH 6.8 with NaOH) having 2.3 g of polyoxyethylene (4,5) lauryl ether acetate dissolved therein, to prepare a magnetic nano particle dispersion liquid.

### Example 2

### Aggregation of the Magnetic Nano Particle Dispersion Liquid and Control of Response Property to a Magnetic Field

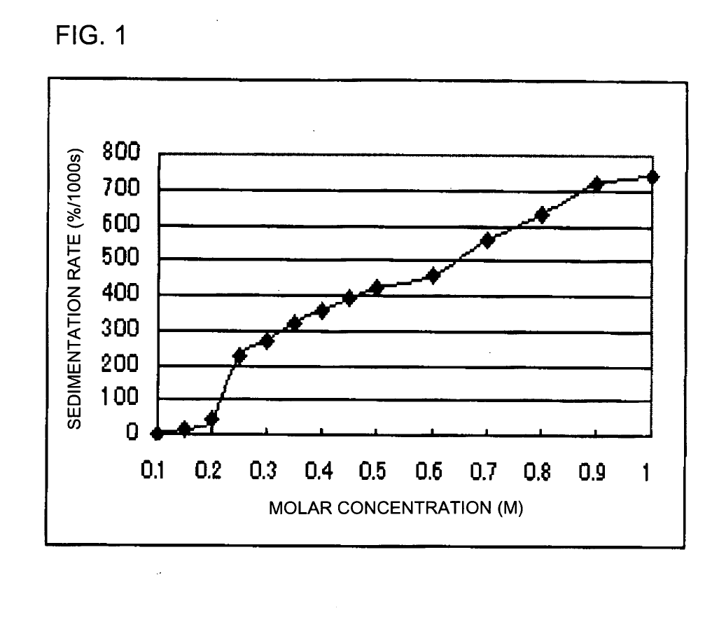

0.5 ml of citrate-phosphate buffer with pH of 7.8 (prepared by changing a concentration of Na₂HPO₄ from 0.1 M to 1 M) was added to 0.5 ml of a 10-fold diluted liquid of the magnetic nano particle dispersion liquid prepared in Example 1, to measure aggregation property in terms of sedimentation rate (measured 150 times under the condition of 1000 rpm at intervals of 10 seconds with a separation characteristics analyzer LuMiFUGE-114). The results were shown in FIG. 1.

As a result, it was found that as the phosphate concentration was increased, the sedimentation rate (that is, aggregation property) was increased. The 10-fold diluted liquid of the magnetic nano particle dispersion liquid did not respond to a magnet of 3000 Oe (237 kA/s), however the response property to the magnet was improved at a concentration of from 0.2 M, and as the aggregation property was increased, the response to the magnet and the collection could be easily carried out. The response to the magnet and the collection were further improved at a concentration of from 0.7 M, and particularly when 1 M citrate-phosphate buffer was added, aggregation was immediately occurred to enable collection with the magnet. When the supernatant was removed and the aggregate was re-suspended in purified water, the sample returned completely to the original transparent dispersion liquid and the response property to the magnet was lost.

### Example 3

### Preparation of Biotinated Magnetic Nano Fine Particles

7.5 ml of 0.1 M MES buffer (pH 6.0) was added to 2.5 ml of the magnetic nano particle dispersion liquid in Example 1, and 19 mg of WSC (water-soluble carbodiimide) and 18 mg of N-hydroxysulfosuccimide (Sulfo-NHS) were added thereto, and the mixture was stirred at room temperature for 30 minutes. 28 mg of Biotin-PEO-Amine (manufactured by PIERCE) was added thereto and stirred overnight. 200 μl of 1 M Tris/HCl (pH 8.0) was added to terminate the reaction, and the sample was purified by a PD-10 column (manufactured by Amersham Bioscience) to give a biotinated magnetic nano particle dispersion liquid.

### Example 4

### Concentration of HRP-avidin by the Biotinated Magnetic Nano Particles

100 μl of HRP-avidin (manufactured by Sigma) solution at various concentrations (1.0, 0.1, 0.01 μg/ml) was added to 100 μl of the biotinated magnetic nano fine particle dispersion liquid in Example 3, then aggregated with a citrate-phosphate buffer (pH 7.8, 1M of Na₂HPO₄), and collected with a magnet. The aggregate was washed with a phosphate buffer, then re-dispersed in purified water, and measured for its peroxidase activity with TMB (manufactured by PIERCE) as substrate. In this step, it was attempted to concentrate the captured HRP-avidin to a dispersion liquid volume of 1/10 or 1/100.

As a result, assuming that 1.0 μg/ml HRP-avidin has a peroxidase activity of 100, the peroxidase activity was 55 when using 0.1 μg/ml HRP-avidin (10 when not concentrated) and the peroxidase activity was 41 when using 0.01 μg/ml HRP-avidin (1 when not concentrated), which indicates that the samples were concentrated 5.5-fold and 41-fold, respectively.

### Example 5

0.5 ml of 0.1 M phosphate buffers (pH 3.0, pH 4.0, pH 5.0, pH 6.0) were added to 0.5 ml of the magnetic nano particle dispersion liquid in Example 1 to prepare 4 samples which were then measured for their sedimentation rate in the same manner as in Example 2. The results are shown in Table 1. The tendency shown in Table 1 indicates that the aggregation property of the magnetic nano particle dispersion product in Example 1 was increased at a pH value of less than 5.

TABLE 1

| pH | Sedimentation rate (μm/s) |
|---|---|
| 3.0 | 50.3 |
| 4.0 | Turbid |
| 5.0 | Not precipitated |
| 6.0 | Not precipitated |

Then, the suspension liquid with pH 4.0 was precipitated with a magnet, and after the supernatant was removed, the aggregate could be formed into the original complete dispersion product by adding a buffer with pH 6.0.

According to the invention, magnetic nano particles can be easily aggregated by changing the salt concentration of a sample liquid, and captured and concentrated with an external magnetic field, while the magnetic nano particles could be easily re-dispersed by lowering the salt concentration.

Magnetic nano particles can be easily aggregated by decreasing the pH of the sample liquid to a value of less than 5, and captured and concentrated with an external magnetic field, and the magnetic nano particles aggregated by changing the pH could be easily re-dispersed by changing the pH of the liquid to a value of 5 or more.

In the invention, the behavior of the magnetic nano particles is changed according to at least one condition selected from the type of a salt in a sample liquid, the concentration of the salt and the pH of the sample liquid, whereby aggregation and dispersion of the magnetic nano particles can be easily controlled, and capture thereof with an external magnetic field can be carried out accurately, certainly and easily.

The invention can provide a method of controlling aggregation and dispersion of magnetic nano particles by which a trace amount of a target substance in a sample can be rapidly and efficiently separated and purified, a method of capturing magnetic nano particles, and a method of treating a liquid containing magnetic nano particles.

What is claimed is:

1. A method of controlling aggregation and dispersion of magnetic nano particles, the method comprising changing, in a sample liquid containing independently dispersed magnetic nano particles having a particle size of 1 to 50 nm, at least one condition selected from the type of a salt present as a medium, the concentration of the salt, and the pH of the sample liquid to thereby control aggregation and dispersion of the magnetic nano particles.

2. The method of controlling aggregation and dispersion according to claim 1, wherein the magnetic nano particles are surface-modified with a compound having a hydrophilic functional group.

3. The method of controlling aggregation and dispersion according to claim 1, wherein the magnetic nano particles are surface-modified with a compound represented by the following formula (I):
R¹O—(CH₂CH₂O)ₙ—L—X Formula (I)
wherein R¹ represents an alkyl or alkenyl group having a carbon chain length of 1 to 20, or a phenyl group which is unsubstituted or substituted with an alkyl or alkoxyl group having a carbon chain length of 10 or less; L may be or may not be present, and when present, L represents an optionally branched alkylene group having a carbon chain length of 1 to 4; X represents a carboxylic acid group, phosphoric acid group, sulfonic acid group or boric acid group; and n represents an integer of 1 to 10.

4. The method of controlling aggregation and dispersion according to claim 1, wherein the salt is at least one of a salt of a polyvalent cation or a salt of a polyvalent anion.

5. The method of controlling aggregation and dispersion according to claim 3, wherein X in formula (I) is a carboxylic acid group, the aggregation condition is pH of less than 5, and the dispersion condition is pH of 5 or more.

6. The method of controlling aggregation and dispersion according to claim 1, wherein the magnetic nano particles comprises an iron oxide or a ferrite.

7. A method of capturing magnetic nano particles, the method comprising:
changing, in a sample liquid containing independently dispersed magnetic nano particles having a particle size of 1 to 50 nm, at least one condition selected from the type of a salt present as a medium, the concentration of the salt, and the pH of the sample liquid to thereby aggregate the magnetic nano particles; and
subjecting the aggregated magnetic nano particles to an external magnetic field to thereby capture the particles.

8. The capturing method according to claim 7, wherein the magnetic nano particles are surface-modified with a compound having a hydrophilic functional group.

9. The capturing method according to claim 7, wherein the magnetic nano particles are surface-modified with a compound represented by the following formula (I):
R¹O—(CH₂CH₂O)ₙ—L—X Formula (I)
wherein R¹ represents an alkyl or alkenyl group having a carbon chain length of 1 to 20, or a phenyl group which is unsubstituted or substituted with an alkyl or alkoxyl group having a carbon chain length of 10 or less; L may be or may not be present, and when present, L represents an optionally branched alkylene group having a carbon chain length of 1 to 4; X represents a carboxylic acid group, phosphoric acid group, sulfonic acid group or boric acid group; and n represents an integer of 1 to 10.

10. The capturing method according to claim 7, wherein the salt is at least one of a salt of a polyvalent cation or a salt of a polyvalent anion.

11. The capturing method according to claim 7, wherein the magnetic nano particles comprises an iron oxide or a ferrite.

12. The capturing method according to claim 7, wherein the magnetic nano particles have a carboxylic acid group thereon, and the method comprises changing the pH of the sample liquid to less than 5 to thereby aggregate the magnetic nano particles.

13. The capturing method according to claim 12, further comprising:
separating and purifying the captured magnetic nano particles; and
changing the pH of a liquid containing the separated and purified magnetic nano particles to 5 or more to thereby re-disperse the particles in the liquid.

14. The capturing method according to claim 7, wherein the magnetic nano particles have, on their surfaces, a compound having an affinity for a target substance in the sample liquid.

15. A method of treating a liquid containing magnetic nano particles, the method comprising changing, in a sample liquid containing independently dispersed magnetic nano particles having a particle size of 1 to 50 nm and having a carboxylic acid group thereon, the pH of the sample liquid to less than 5 to thereby aggregate the magnetic nano particles.

16. The treatment method according to claim 15, further comprising changing the pH of the sample liquid containing the aggregated magnetic nano particles to 5 or more to thereby re-disperse the magnetic nano particles.
